(19) United States
(12) Patent Application Publication
(10) Pub. No.: US 2025/0222407 A1
(43) Pub. Date: Jul. 10, 2025

(54) HOT MELT MEMBRANE SPACERS

(71) Applicant: Aqua Membranes, Inc., Albuquerque, NM (US)

(72) Inventors: Rodney Herrington, Albuquerque, NM (US); Kevin Roderick, Albuquerque, NM (US); Christopher Kurth, Eden Prairie, MN (US); Kendall Weingardt, Albuquerque, NM (US)

(21) Appl. No.: 19/092,881

(22) Filed: Mar. 27, 2025

Related U.S. Application Data
(63) Continuation of application No. PCT/US2023/075393, filed on Sep. 28, 2023.
(60) Provisional application No. 63/410,735, filed on Sep. 28, 2022.

(51) Int. Cl. B01D 63/10; B01D 67/00

(52) U.S. Cl. CPC B01D 63/1031; B01D 67/0081; B01D 2313/143

(57) ABSTRACT

Hot melt printed spacer membrane elements offer the unique advantage of applying any pattern on the membrane surface to act as the feed spacer material. This technique also eliminates damage to the active surface of the membrane by avoiding photo curing, either UV, light or other wavelengths of energy. By printing narrow features, the bending moment at the membrane surface imparted by the printed feature will be less than the bending moment imparted by a wider printed feature, thereby minimizing damage to the sensitive membrane coating.

### TECHNICAL FIELD

The subject invention relates to a membrane system utilized for the separation of fluid components, specifically spiral-wound membrane elements or flat sheet membrane systems.

### BACKGROUND ART

In cross-flow filtration, a feed fluid flows through a filter and is released at the other end, while some portion of the fluid is removed by filtration through a membrane surface which is parallel to the direction of fluid flow. Various forms of cross-flow filtration exist including plate-and-frame, cassette, hollow-fiber, radial, or spiral wound systems. Plate-and-frame, cassette, radial, and spiral-wound filtration modules often rely on stacked membrane layers which provide spacing between adjacent layers of filtration membrane. The present invention primarily relates to, but is not limited to, spiral wound membrane elements.

Spiral-wound membrane filtration elements are well known in the art, and comprise a laminated structure having a membrane sheet sealed to or around a porous permeate carrier which creates a path for removal, longitudinally to the axis of the center tube, of the fluid passing through the membrane to a central tube, while this laminated structure is wrapped spirally around the central tube and spaced from itself with a porous feed spacer to allow axial flow of the fluid through the element from the feed end of the element to the reject end. Traditionally, a feed spacer mesh is used to allow flow of the feed water, some portion of which will pass through the membrane, into the spiral wound element and allow reject fluid to exit the element in a direction parallel to the center tube and axial to the element construction.

Improvements to the design of spiral wound elements have been disclosed in U.S. Pat. No. 6,632,357 to Barger et al., U.S. Pat. 7,311,831 to Bradford et al., and patents in Australia (2014223490), Japan (6499089), China (CN105163834B), Israel (240883), and South Korea (10-2196776) entitled “Improved Spiral Wound Element Construction” to Roderick et al. which replaces the feed spacer with islands or protrusions either printed, deposited or embossed directly onto the active or inactive surface of the membrane, or on the permeate carrier. U.S. Pat. No. 11,090,612 entitled “Graded spacers for filtration wound elements” to Roderick, et al., describe the use of height graded spacer features which are used to alter feed flow characteristics in a spiral wound element. U.S. Pat. No. 11,040,311 entitled “Interference Patterns for Spiral Wound Elements” to Roderick, et al., describes patterns in spiral wound elements that keep membrane feed spaces open but also provide support for the membrane envelope glue areas during rolling. US patent application PCT/US18/55671 entitled “Bridge Support and Reduced Feed Spacers for Spiral-Wound Elements” to Roderick et al. describes support features that are applied to the distal end (farthest end from the center tube) of the membrane envelop to provide support during gluing and rolling of the spiral wound element. US provisional application number PCT/US21/40353 entitled “Variable Velocity Patterns in Cross Flow Filtration” to Herrington et al. describes support patterns that vary in size from the feed to the reject end of the membrane feed space in the feed flow path parallel to the center tube in order to control the velocity of the feed solution as the concentration of the feed solution increases from the feed to the reject end of the spiral wound element. U.S. Pat. No. 11,083,997 to Roderick, et al. entitled “Non Nesting Patterns” describe denser patterns in the feed and reject ends of the membrane feed space, and a more open pattern in the middle, in order to avoid nesting of the printed patterns during element fabrication, particularly during the membrane envelop gluing process to support the glue lines. PCT application PCT/US21/26030 entitled “Independent Spacers and Methods” to Herrington, et al., describes various methods for applying spacers to the membrane surface that does not expose the membrane surface to UV or visible light from ink jet, stencil, or screen printing processes that are photo cured. U.S. patent application No. 63/294,377 entitled “High Rejection Element” to Herrington, et al., describes membrane printing and assembly processes that provide support to the membrane sheet in high stress concentration areas to avoid damage to the membrane active layer. U.S. patent application No. 63/294,378 entitled “Spiral Element Enhanced Capacity” to Kurth, et al., describes membrane printing and assembly processes that provide improved membrane design features to increase the permeate flow capacity of spiral wound elements.

Much of the printed spacer technology to date has used multi-pass UV or light cured ink jet processes that build up the height of the pattern in layers. Alternately, single layer stencil printing processes have been used that utilize epoxies or UV or light cured urethanes. Stencil printing offers the possibility of faster printing vs light or UV cured photo-polymer ink jet processes because a stencil can provide a desired spacer height in a single pass, whereby ink-jet printing is usually applied in multiple passes.

### BRIEF SUMMARY OF THE INVENTION

The present invention describes a novel method of applying and configuring printed spacer features that avoid damage to the polyamide coating of a thin film composite (TFC) membrane due to the bending effects of the printed features that are adhered to the TFC surface, and also facilitate maximum speed of printing patterns on the membrane surface, and innovative applications of thermally cured waxes and hot melt materials.

Example embodiments of the present invention provide a membrane assembly for a spiral wound filtration element, comprising: (a) a membrane sheet comprising a thin film composite structure comprising a porous structural layer, a support layer, and an active membrane layer; (b) a plurality of edge spacers, comprising line segments of hot melt disposed on the active membrane layer, where each edge spacer has a length less than one fourth of the distance between first and second opposing edges of the membrane sheet, positioned near the first and second opposing edges and disposed with a long axis perpendicular to the first edge, wherein adjacent edge spacers are separated in a direction parallel to the first edge by a first distance; (c) a plurality of intermediate spacers, comprising line segments of hot melt disposed on the active membrane layer, wherein each intermediate spacer has a length less than one fourth of the distance between first and second opposing edges of the membrane sheet, positioned in between the first and second opposing edges and disposed with a long axis perpendicular to the first edge, wherein adjacent intermediate spacers are separated in a direction parallel to the first edge by a second distance, where the second distance is greater than the first distance.

In some embodiments, the second distance is an integer multiple of the first distance. n some embodiments, each edge spacer has a length of at least one inch and no more than four inches. In some embodiments, the plurality of intermediate spacers comprise a plurality of sets of intermediate spacers, wherein each set of intermediate spacers comprises a plurality of intermediate spacers each disposed along a single line perpendicular to the first edge, wherein the single line coincides with an edge spacer, and therein the intermediate spacers in a set comprise line segments separated from each in a direction along the single line by a third distance, wherein the third distance is greater than the first distance.

In some embodiments, each set of intermediate spacers is separated from an adjacent set of intermediate spacers by third distance, wherein the third distance is an integer multiple of the first distance. In some embodiments, each intermediate spacer has a cross-section that is rounded at an end away from the membrane sheet. In some embodiments, each intermediate spacer has a cross-section that has convex sides. In some embodiments, each intermediate spacer has a cross-section that has concave sides. In some embodiments, the hot melt is liquid at temperatures above 100 C. In some embodiments, the hot melt is liquid at temperatures above 170 C. In some embodiments, the hot melt has low tackiness. In some embodiments, the second distance is 3 times the first distance. n some embodiments, the intermediate spacers are 100 to 1500 microns wide, 250 to 5000 microns long, and 75 to 1200 microns tall.

Example embodiments of the present invention provide a method of making a membrane assembly, comprising: (a) providing a membrane sheet, comprising a thin film composite structure comprising a porous structural layer, a support layer, and an active membrane layer; (b) forming a plurality of edge spacers by depositing hot melt on the active membrane layer in a plurality of line segments, where each edge spacer has a length less than one fourth of the distance between first and second opposing edges of the membrane sheet, positioned near the first and second opposing edges and disposed with a long axis perpendicular to the first edge, wherein adjacent edge spacers are separated in a direction parallel to the first edge by a first distance; (c) forming a plurality of intermediate spacers by depositing hot melt on the active membrane layer in a plurality of line segments, where each intermediate spacer has a length less than one fourth of the distance between first and second opposing edges of the membrane sheet, positioned in between the first and second opposing edges and disposed with a long axis perpendicular to the first edge, wherein adjacent intermediate spacers are separated in a direction parallel to the first edge by a second distance, where the second distance is greater than the first distance.

In some embodiments, the second distance is an integer multiple of the first distance. In some embodiments, each edge spacer has a length of at least one inch and no more than 3 inches. In some embodiments, the plurality of intermediate spacers comprise a plurality of sets of intermediate spacers, wherein each set of intermediate spacers comprises a plurality of intermediate spacers each disposed along a single line perpendicular to the first edge, wherein the single line coincides with an edge spacer, and therein the intermediate spacers in a set comprise line segments separated from each in a direction along the single line by a third distance, wherein the third distance is greater than the first distance. In some embodiments, each set of intermediate spacers is separated from an adjacent set of intermediate spacers by third distance, wherein the third distance is an integer multiple of the first distance.

In some embodiments, the second distance is 3 times the first distance. In some embodiments, each intermediate spacer has a cross-section that is rounded at an end away from the membrane sheet. In some embodiments, each intermediate spacer has a cross-section that has convex sides. In some embodiments, each intermediate spacer has a cross-section that has concave sides. n some embodiments, the hot melt is liquid at temperatures above 170 C.

In some embodiments, forming a plurality of edge spacers comprises transporting a hot melt dispenser from near the first edge to near the second edge along a direction perpendicular to the first edge, and applying hot melt through the dispenser while the dispenser travels from near the first edge to a position at a distance from the first edge equal to the length of the edge spacer, and while the dispenser travels from a position at a distance from the second edge equal to the length of the edge spacer to near the second edge. In some embodiments, orming a plurality of intermediate spacers comprises, while transporting the dispenser, applying hot melt through the dispenser while the dispenser travels from a position of the start of an intermediate spacer to a position of the end of an intermediate spacer. In some embodiments, forming a plurality of intermediate spacers comprises applying hot melt through the dispenser on less than all of the dispenser excursions from the first edge to the second edge. In some embodiments, the dispenser dispenses hot melt at a rate of less than 100 nanoliters per drop. In some embodiments, the dispenser dispenses hot melt at a rate of less than 50 nanoliters per drop. In some embodiments, the dispenser dispenses hot melt at a rate of less than 10 nanoliters per drop.

Example embodiments provide a method of producing a recycled spiral wound element, comprising: (a) providing one or more initial spiral wound elements having spacing features comprising hot melt; (b) disassembling the one or more initial spiral wound elements; (c) recovering some or all of the hot melt from the initial spiral wound element; (d) using the hot melt to produce one or more membrane assemblies as described herein; (e) winding the one or more membrane assemblies into a recycled spiral wound element.

### BRIEF DESCRIPTION OF THE DRAWINGS

FIG. 1 is an exploded view of a spiral wound membrane element.

FIG. 2 is an exploded view of a partially assembled spiral wound membrane element.

FIG.3 is a view of a printed membrane surface showing damage of the active membrane layer from spacing features that are wide in the longitudinal direction of element rolling.

FIG.4 is an end view of a spiral wound element showing the geometry of printed features and damage to the membrane surface.

FIG. 5 is an end view of a spiral wound element showing narrow printed features to avoid damage to the membrane surface when the membrane sheet is wrapped around the center tube.

FIG. 6 is a view of the print pattern on a membrane sheet that facilitates high speed printing using a single or multiple pass thermally cured material.

FIG. 7 is a schematic illustration of a hot melt production plotter layout.

FIG. 8 is a side view of printed spacers with and without sharp edges on the opposing membrane surface.

FIG. 9 is a side view of a concave hot melt spacer showing the buildup of hot melt material drops.

FIG. 10 is a side view of a hot melt spacer with concave features.

FIG. 11 is a side view of a hot melt spacer with convex features.

### MODES FOR CARRYING OUT THE INVENTION AND INDUSTRIAL APPLICABILITY

Hot Melt Materials. Hot melt technology as in the present invention can have significant benefits over alternative spacer application technologies. “Hot melt” as used herein refers to any polymer-based glue that is applied in a molten state. The application of the hot melt can be by a glue gun, high frequency tappet type nozzle heads, heated stencil, and other techniques. Hot melt can be used in a variety of settings due to its versatility, including packaging, bookbinding, carton-making, graphic arts, tapes and labels, product assembly, as well as spacers in spiral wound, flat plate, and pleated filtration and membrane systems.

Hot melt as in the present invention has several beneficial characteristics. It is fast-acting and can be applied in one or more layers depending on the desired height of the pattern. The time to cure, or set, can be adjusted based on the needs of the application. Hot melt is generally safe to use and environmentally friendly. Hot melt can be used to bond difficult surfaces. It is inherently safe and is easy to ship and store with a long shelf life. Hot melt, which is polymer based, can be faster, more cost-effective, more adhesive, and produce a lower amount of volatile organic compounds than solvent-based adhesives. As such, the hot melt material will produce less undesirable volatiles that can contaminate potable drinking water during the reverse osmosis (RO) process. This characteristic helps ensure compliance with toxicology protocols when tested against the requirements of NSF International. NSF International verifies that water contact materials do not extract materials that can contaminate fluids (such as water) and that can cause bad health affects for the consumer. Due to its chemical nature, hot melt can come in any number of forms. This includes granuals, pellets, bags, cakes, drums, bricks, slats, and pillows. Hot melt can also be applied in several ways, including through high frequency print head nozzles, extrusion, melt blowing, spiral spraying, screen printing, stencil printing, and slot die coating. The dispensing equipment for hot melt can come in the form of melt reservoirs, vacuum conveyance, drum or pail unloaders, and pre-melters.

In general, hot melt is composed of a polymer (which can come in various forms) and several additives. These additives include resins, waxes, antioxidants, and plasticizers. Other chemicals can be added to give hot melt more properties.

Polymers. The basic constituents of hot melts (and many types of glue) are polymers. These are long, repetitive chains of certain molecules that have different properties based on the length of the chains and the type of the molecule. The primary polymers used in hot melts are ethylene-vinyl acetate (EVA), polyolefins, polyamides and polyesters, styrene block copolymers, polyethylene, and ethylene-methyl acrylate (EMA) or ethylene n-butyl acrylate (EnBA).

Polymers give hot melt its strength and flexibility, heat resistance, impact resistance, and shear properties. These characteristics are guided largely by the type of polymer, its molecular weight, and its amount. Greater polymer content provides higher viscosity, and greater flexibility and toughness. With lower polymer content, viscosity is usually lower.

Tackifying resins. Resins define the tack of hot melt. Tack is the measure of the stickiness of an adhesive, essentially how long the adhesive stays stuck after it is applied. Resins determine the wetting of an adhesive (i.e., how long it remains a liquid while in contact with the substrate surface). Low tack resins are preferred for printed spacer technology on membranes. Typically, the print pattern on a membrane is only applied on one half of a membrane sheet. The sheet is folded in half so that the unprinted side faces the printed side. It is important that the hot melt material not have a tacky surface. Spacers that come in contact with the unprinted side of the membrane should not stick to the unprinted surface. During rolling, the membrane sheets will shear past each other slightly, and the hot melt spacers should not stick to the opposing surface (which could damage the opposing surface as the two surfaces move relative to each other during rolling). The active membrane layer is extremely thin, and any damage to the active layer will damage the salt rejection characteristics of the membrane assembly.

Resins also have an influence on the adhesive nature of the hot melt. The choice of resin is determined by its compatibility with the main polymer, its softening point, and the specific adhesion. The primary types of tackifying resin used in hot melt are rosin and hydrogenated rosin, C9, hydrogenated hydrocarbon, terpene phenolics, rosin ester, and C5. Pure aromatic monomers are also used.

Waxes. Wax in hot melt primarily control the set speed and open time. The open time is the amount of time it takes to make a bond. This can range from a few seconds to an endless duration. The set speed measures how quickly the hot melt can form a bond of some acceptable strength. In addition to set speed and open time, wax also influences the heat resistance and sub-ambient (i.e., below application temperature) adhesion of hot melt. The main types of wax used in a hot melt are natural waxes, microcrystalline waxes, and synthetic waxes. The characteristics of the wax are determined by the percent of crystallinity, melting point, and molecular weight. With lower wax content, hot melt will have higher viscosity and greater flexibility, and will bond more aggressively. With less wax, hot melt will have a lower viscosity, set faster, and bond less aggressively.

Antioxidants. Antioxidants are used in hot melts primarily to protect the material from degradation over the period of its shelf life. Some of the commonly used antioxidants in hot melt include phenols, aromatic amines, phosphates, phosphites, and BHT. Along with stabilizers, antioxidants are added in small amounts and do not influence the physical properties of the hot melt. They protect the hot melt not only during its shelf life but also during its molten state when it is being applied and when it is being compounded.

Plasticizers. Besides the base polymer and tackifying resin, plasticizers are the most common additive in hot melt. In fact, they are used as a sort of second base polymer to give the hot melt greater flexibility and toughness. Plasticizers are often hydrocarbon oils that are low in aromatic content and which have the chemical characteristics of paraffin. Ideally, plasticizers have low volatility, are transparent, and have no odor. Using a plasticizer, a hot melt can achieve a lower melt viscosity and wet faster.

In addition to these main ingredients, hot melt can have any of several other additives, and combinations of additives, to give it certain desired characteristics. Biocides can be added to prevent bacterial growth. Fillers add bulk and strength while reducing cost. Hot melt can also come with flame retardants and various pigments or materials such as copper, silver, carbon, and other conductive materials, and nano-particles that can provide electrical characteristics to printed spacers, enabling scale and biofilm reduction.

Important defining characteristics of hot melt are viscosity, molten color, failure temperature (for shear adhesion and peel adhesion), softening point, substrate specific adhesion, thermal stability, cold crack formation, loop tack, and various mechanical properties.

Viscosity. Viscosity is the measure of the thickness of a liquid or how much it resists flow. High viscosity liquids move very slowly (think of thick oil). Lower viscosity liquids, like water, flow more easily. The viscosity of hot melt is not just a single value but can depend on the application temperature (which can range from 250 to 400 degrees Fahrenheit). Higher viscosity is typically better for hot melt applications for printed spacers because they can build height at faster travel speeds.

Molten color. The color of hot melt is measured on a numerical scale using both subjective and quantitative methods. These include the Gardner, Hunter, and Saybolt methods and the Yellowness index. Color is not usually a key criteria for printed spacer applications since the spacers are typically out of view.

Peel. Peel is the measure of how much force is needed to break the bond between two bonded surfaces. Peel is expressed in pounds per inch and can be measured at different angles (right angles and 180 degrees are the most common) and for different surfaces. Peel is an important characteristic for printed spacer applications since the printed spacers are discrete components and should not move in spiral wound applications. Acceptable adhesion for printed spacers is demonstrated when the feature is removed from the polyamide surface, and the polymer membrane material stays attached to the hot melt feature exposing the polysulfone support layer below.

Failure temperature. As the name implies, the failure temperature is the temperature at which the hot melt stops working. There are two kinds of failure temperature measurements used to characterize hot melt.

Peel Adhesion Failure Temperature (PAFT). At greater temperatures, it becomes easier to peel away two surfaces bonded with hot melt. The PAFT measures how much the hot melt can resist peeling at higher temperatures.

Shear Adhesion Failure Temperature (SAFT). Shear is a force that exists as one surface slides over another. In a shear test, a specimen is vertically mounted and a weight attached. How long it takes for the surfaces to detach from each other indicates how strong the hot melt is.

Softening point. The softening point of hot melt (or any glue) is the temperature at which the glue starts flowing. The primary determinants of hot melt's softening point are the melting point of the wax being used and the transition temperature of the base polymer. The application temperature of hot melt materials for printed spacers is preferably in the range of 170 C. but can vary widely from 100 C. to 200 C. based on the components in the hot melt material.

Substrate-specific adhesion. This measure depends on the kind of material is being used with the hot melt. Characteristics such as bond strength can be determined using actual substrates. For printed spacer technology where the substrate is a membrane, good adhesion is characterized by the ability of the hot melt to adhere to the thin membrane coating and separate it from the underlying polysulfone layer.

Thermal stability. How stable hot melt is under different temperature changes indicates how durable it will be overall. Hot melts with good pot stability do not char or decompose at higher temperatures.

Mechanical Properties. There are various mechanical properties that are relevant to hot melt. These include tensile strength (how much force is needed to break a sample), yield point (how much stress can be applied to hot melt before it deforms permanently), elongation at break (how long a specimen will stretch before breaking), and Young's modulus (stress over strain ratio). Other properties are combinations of these.

The different materials used to make hot melts and the resulting properties of the adhesive mean there is a great diversity in the function, performance, and cost of hot melt products.

Hot melt is attractive for nano-membrane filtration fabrication according to the present invention in part because UV curing is not a part of the process, as it is in photo-polymer printing. In UV or light cured applications, the energy imparted by the UV or light source can damage the polysulfone substrate that affects the flux and salt rejection characteristics in nano-membrane applications.

Feed Spacers and Spiral Wound Elements. The feed spacer in a spiral wound filtration element is required to maintain a channel for fluid to flow from the feed to reject end of the feed channel, and the spacer design also impacts local flow velocities, turbulence, stagnation zones and other fluid flow conditions. Extruded mesh feed spacers have been used traditionally in membrane manufacturing due to the ease of integration in the production process, but by the nature of their design many of their hydrodynamic characteristics are dependent on the thickness of the spacer. Conventional mesh spacers also provide uniform support characteristics in the feed space all the way from the distal end from the center tube to the proximal end of the membrane sheet near the center tube. Printed feed spacers allow for unique design characteristics unobtainable with conventional extruded or woven mesh spacers, since their thickness and geometry can be changed independently to yield a wide range of configurations which can be tailored to specific applications or specific challenges found in spiral wound membrane element construction.

Cross-flow filtration, by its nature, relies on some portion of the feed fluid to pass through the membrane and become part of the permeate (product fluid), thus creating a situation where the quantity of the feed fluid is constantly being reduced as it passes through the membrane. The higher the portion of permeate produced, the lower the portion of feed/concentrate fluid that remains flowing through the membrane element. As a fluid flows through the element, a portion of the fluid passes through the membrane. Modeled simply, a constant flux through the membrane produces a gradually decreasing flow of the feed solution as it flows from the feed to the reject end of the feed space in the element. In reality, the amount of fluid passing through any location along the feed flow path depends on local flow conditions and local concentrations of solutes or suspended materials, as well as the local pressure which also depends on any back-pressure in the feed space as well as from the permeate side of the element locally.

During fabrication of a spiral wound element, permeate carrier material is attached to the center tube by tape or bonding, the membrane envelope is placed adjacent to the permeate carrier, and the flat sheet assembly is glued—to seal the permeate carrier envelope-and the envelope is rotated around the center tube with a rotating mechanism such as a lathe. The center tube is captured or keyed to the lathe so that the lathe can rotate the center tube and wind the membrane envelope and permeate carrier around the center tube. Torque on the center tube must be adequate to roll the envelope until the entire envelope is wrapped around the center tube. Sufficient tension must be maintained in the membrane envelope to ensure the glue penetrates completely through the permeate carrier and contacts both membrane leaves to ensure the membrane envelope is completely sealed. As the membrane envelope is wrapped around the center tube, the diameter of the element increases. However, the torque and forces on the membrane envelope are greatest at the center tube where the diameter is smallest. Greater force proximal to the center tube creates greater force on the membrane envelope, particularly the feed space, during rolling. Ann important advantage of printed spacer technology is that more open feed spacer channels can be created, and closer spacing of printed spacers can be provided at the center tube where stress concentrations are higher.

The present invention addresses the issues of reduced flux and rejection of salts at the membrane surface by using hot melt material to create the spacers on the membrane sheet. Hot melt material is applied as a liquid at elevated temperature which solidifies as temperature decreases and therefore does not require UV or light to drive chemical reactions leading to solidification of the liquid resin in the form of a printed pattern. Accordingly, there is no UV or other wavelength of energy damage imparted to the membrane active surface that can damage the flux or rejection of the membrane surface. Hot melt material also has a significant cost advantage versus light cured adhesives. In addition, in contrast to UV or light cured photo polymers, hot melt material can be recovered and recycled at the end of life of the membrane element.

Another issue with previously used printing methods is that before solidification of the printing materials—due to low surface tension and/or viscosity of the printing material—the photo-polymer material is able to spread, or overspray, and cover more of the membrane surface than was intended. This additional coverage can block membrane flow leading to reduced efficiency. Due to the higher viscosity of hot melt materials, and the fact that it cools as it hits the surface, the ability to spread over the membrane is reduced.

Another aspect of the present invention is that the hot melt material can be applied quickly by printing the pattern in one direction with the print head or multiple print heads. The pattern first lays down a continuous line pattern at the edge of the membrane, typically 3 inches, though it can be more or less than 3 inches, that provides support for the glue line when the membrane envelop is glued to seal the permeate carrier between the two membrane sheets. The print head continues to print across the length of the membrane sheet laying down a series of short dashed or curved segments, or spacers, that create the support patterns that are less dense in the middle of the membrane sheet than at the edges. At the opposite side of the sheet, the print head then lays down the support lines on the reject end of the membrane sheet in the same fashion as the inlet feed support lines. The print head can then be indexed down the longitudinal length of the membrane sheet by a preferred distance of 0.100 inches, and the print head then proceeds back in the opposite direction of the first printed line. Alternative line spacings can range from 0.040 inches to 1.00 inches. In this second pass, the dense pattern on the edges of the membrane is printed, but the short patterns in the open area of the membrane may or may not be printed, based on the desired longitudinal spacing of the short patterns in the middle of the membrane sheet. For example, the print pattern may skip printing the short dashes, or segments, on two passes of the print head. Thereby, the dense line pattern on the feed and reject ends of the membrane sheet will be printed every 0.100 inches down the longitudinal length of the membrane, but the short dashed pattern will only be printed every 0.300 inches down the longitudinal length of the membrane sheet. Of course, many variations can be made in the longitudinal length of the spacing as well as the length of the edge print pattern, and the spacing of the shorter straight or curved patterns in the middle of the membrane.

A system for applying the hot melt to the membrane surface can comprise a two axis gantry system as well as an adjustment mechanism for changing the height of the print head above the membrane sheet. This system can be controlled by a programmable logic controller (PLC) and the print pattern can be loaded into the program with conventional software designed to control plotters. High frequency print heads are utilized to apply the hot melt material to the membrane sheet. The membrane sheet can be held in place with a vacuum table to ensure the membrane sheet does not move, and is held at a fixed height in the printer. Individual sheets can be printed, or a roll to roll system can feed the membrane to the print area. The hot melt feed system can be configured from conventional bulk hot melt feed systems with heated feed lines to the print heads. A pressure control system can be integrated in the hot melt feed system to ensure that a constant and steady supply of hot melt material is delivered to the print heads. While a single print head can print a membrane sheet, multiple print heads operating together can reduce the time required to print a full sheet.

Drop volume, melt temp, feature size, support damage (set speed vs print speed). Printing with hot melts on membranes requires the applied drop to have a low enough amount of thermal energy to avoid damaging the 30 nm to 1 micron separating layer on the membrane being coated. This leads to a preferred process using resins having a solidification temperature between 45 C. and 200 C. Materials with lower solidification temperature are unable to withstand typical cleanings. Materials with higher solidification temperature can lead to damage of the membrane by deposition of the hot material on the membrane. Drop volume also impacts the amount of thermal energy being applied, and as a result, materials with a higher application temperature have been found to be better applied with multiple small droplets. Preferred features are typically 100-1500 microns in diameter or lengths of dash segments preferably 2500 microns, but as little as 250 microns and up to 5000 microns or longer, and heights are preferably from 75 microns to 1200 microns or greater. Preferred droplet volumes from the print head per strike are less than 100 nanoliters, but more preferably less than 50 nanoliters., and even more preferably less than 10 nanoliters.

Surfaces can be oleophobic or chemically modified, or have microfeatures that minimize spreading.

Preferred print features can also have a section in the middle of the feature (halfway between the membrane base, and the top of a feature, where the diameter of the feature is wider or narrower than the base. This geometry can give improved mixing performance.

Sharp edges at the top of a feature can lead to damage to the opposing membrane surface that the feature is in contact with. Preferred features can have a profile that resembles a dome, mostly free of sharp angles. Due to the cooling and coalescing feature of the hot melt material, the surface of the feature is typically rounded and does not have sharp spikes or edges.

The typical durometer range for hot melt materials applied to the membrane surface are preferably about 70 Shore A durometer. Alternative durometers can range from 80 to as low as 40 Shore A hardness

Preferred patterns have a repeating pattern in the center region (i.e., not the denser edge pattern) that are divisible into integer ratios. More specifically the center section may have features that are in a row from edge to edge, where the feature position is the same for the left half and right half, or the left third, center third, and right third, etc. down to the case where every feature in a row from edge to edge have the same spacing. Positions from one row to the next may align, or may be offset, but the row position symmetry is preferably the same. This leads to more effective mixing and an improved application process.

Hot melt application is a non-contact process whereby the print head is positioned preferably 0.2 inches above the membrane surface, but the range can be 0.02 to 0.5 inches above the membrane surface. Non-contact printing avoids damage to the membrane surface that can be a problem for application techniques such as screen or stencil printing. Hot melt dispensing also has the advantage of using fewer print heads than photo polymer ink jet type printing. Fewer print heads means that maintenance to clean heads is faster with less operational down time.

There are a number of characteristics of hot melt material that affect the deposition rate of material to a substrate. These include viscosity, temperature, print head travel speed, frequency of the print head per drop, nozzle size, pressure of the hot melt on the nozzle, and other factors. In an example embodiment, a pattern that is 0.02 inches (0.5 mm) wide and 0.02 inches (0.5 mm) tall, with a print had speed of 15 mm/s, will have a print head frequency of about 400 Hz and 10 nanoliter drop size. One of the advantages of a stream of small drop sizes is that hot melt applied at a nominal temperature of 170 centigrade, for example, from the print head will have a lower joule heat content than a larger drop, and will cool at a faster rate than a big drop owing to the smaller surface area versus heat dissipation rate advantage of a smaller drop versus a large drop. A series of small drops will also impart less heating to the substrate than a continuous stream of hot melt applied from a syringe type nozzle. Faster cooling will minimize damage to the underlying active polymer membrane coating or support layers, and will minimize membrane salt rejection damage. Minimal overspray from a high frequency hot melt tappet type print head will also minimize the loss of flux (volume of fluid passage through a given area of surface) due to overspray, that is characteristic of ink-jet type printing. Hot melt printing does not overspray due to rapid cooling, and will not spread as adhesives do in a stencil type system. Prior to UV or light curing of stencil type adhesives, the adhesives have a tendency to spread out around the printed spacer and reduce the active membrane surface area, thereby reducing flux and productivity of the membrane element.

A wide variety of characteristics will determine the build height and print speed. Various manufacturers can offer hot melt materials that work well for creating printed spacers on membrane substrates. With these various characteristics and precision control of the X and Y directions of the gantry system, unlimited configurations of printed spacers can be fabricated at practical heights for feed spacer applications.

One aspect of more open feed spaces is that the concentration of forces applied to the membrane envelope, and consequently, the feed spacers, result in higher forces applied to the feed spacer elements, particularly near the center tube. Hot melt printing of spacers according to the present invention can also address these concerns.

The feed shaping features employed can be of any of a number of shapes, including round dots, ovals, bars with rounded ends, lenticular forms, stretched polygons, lines or other geometric shapes. Due to the shape of the features and the fact that the fluid must traverse around the outside of the features, the fluid flow velocity will change locally in the areas between the feed spacing features from the feed to reject end of the membrane element. Efficient printed spacer patterns will allow maximum flow from the feed to the reject end of the membrane, will provide very little resistance to flow from the feed to reject end, the features will minimize formation of stagnation points on the leading and trailing edge of the spacer, and will help promote mixing of the feed solution to reduce concentration polarization in the feed space.

In spiral wound elements, the membrane leaf is folded at the center line where the center line comes in contact with the permeate carrier at the center tube prior to rolling. Fold protection is described in the prior art. Fold protection usually consists of tape applied along the width of the membrane sheet where it is folded. The prior art also discusses fold protection that is applied by printing or otherwise applying a polymer or other resin as the fold protection material. Fold protection is used to protect the membrane leaf where it is creased when folded in order to avoid damage from the crease. Damage in the crease without fold protection can result in loss of rejection and flux in the finished membrane element. Fold protection can be utilized uniquely in printed spacer technology by extending the fold protection over the top of the printed spacer features near the center tube to help avoid stress concentration of the printed spacer features from damaging the active surface of the membrane on the unprinted side of the membrane leaf.

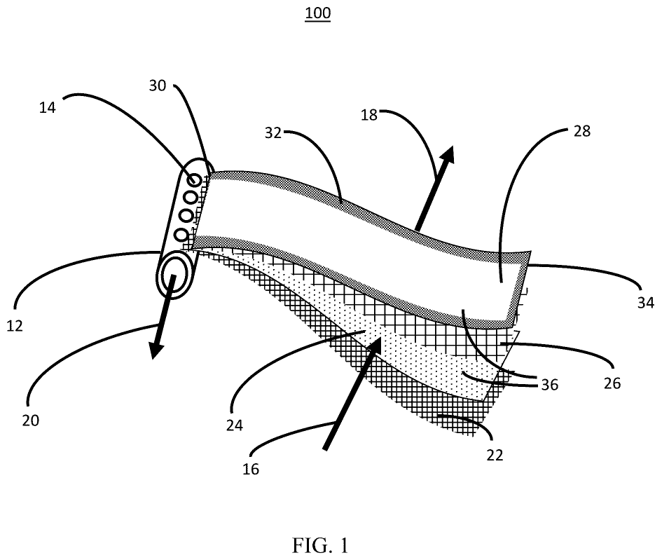

FIG. 1 is a schematic illustration of a conventional spiral wound membrane element prior to rolling, showing important elements of a conventional spiral wound membrane element 100. Permeate collection tube 12 has holes 14 in collection tube 12 where permeate fluid is collected from permeate carrier 22. In fabrication, membrane sheet 36 is a single continuous sheet that is folded at center line 30, comprised of a non-active porous support layer on one face 28, for example polysulfone, and an active polymer membrane layer on the other face 24 bonded or cast on to the support layer. A porous polyester structural layer can be in between the support layer and the active layer. In the assembled element, active polymer membrane surface 24 is adjacent to feed spacer mesh 26, and non-active support layer 28 is adjacent to permeate carrier 22. Feed solution 16 enters between active polymer membrane surfaces 24 and flows through the open spaces in feed spacer mesh 26. As feed solution 16 flows through feed spacer mesh 26, particles, ions, or chemical species, which are excluded by the membrane are rejected at active polymer membrane surfaces 24, and molecules of permeate fluid, for instance water molecules, pass through active polymer membrane surfaces 24 and enter porous permeate carrier 22. As feed solution 16 passes along active polymer membrane surface 24, the concentration of materials excluded by the membrane increases due to the loss of permeate fluid in bulk feed solution 16, and this concentrated fluid exits the reject end of active polymer membrane sheet 24 as reject solution 18. Permeate fluid in permeate carrier 22 flows from distal end 34 of permeate carrier 22 in the direction of center tube 12 where the permeate fluid enters center tube 12 through center tube entrance holes 14 and exits center tube 12 as permeate solution 20. To avoid contamination of the permeate fluid with feed solution 16, non-active polymer membrane layers 28 are sealed with adhesive along adhesive line 32 through permeate carrier 22 thereby creating a sealed membrane envelope where the only exit path for permeate solution 20 is through center tube 12. Typically, the width of the adhesive line 32 is 1″-3″ after the adhesive has been compressed during the rolling process.

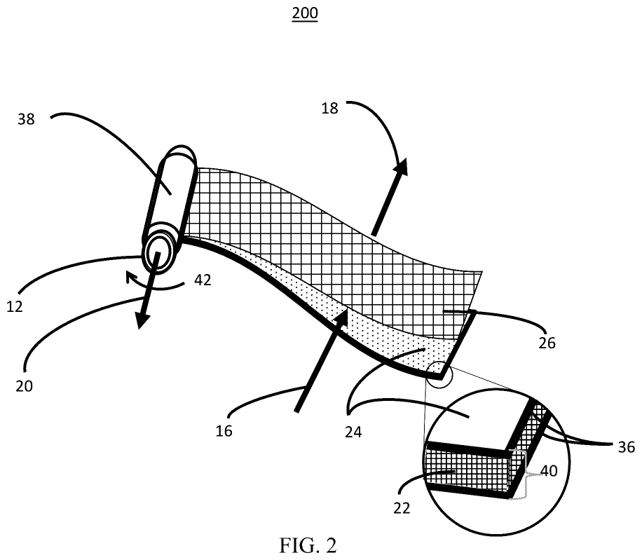

A partially assembled spiral wound membrane element 200 is shown in FIG. 2. A membrane envelope 40 comprises, as described in connection with FIG. 1, a membrane sheet 36 folded at one end with a permeate carrier 22 disposed therebetween the membrane sheet and sealed along the edges with a suitable adhesive line 32 (FIG. 1). In the conventional design of membrane element once rolled, a feed spacer mesh 26 is placed adjacent to envelope 40 to allow the flow of feed fluid 16 to flow between layers of membrane envelope 40 and expose all of the active polymer surfaces 24 of the membrane sheet to feed fluid. Permeate, or product fluid is collected in the permeate carrier 22 inside membrane envelope 40 and proceeds spirally down to center tube 12 where the product, or permeate fluid is collected while the reject stream 18 exits the element. A single spiral wound element may comprise a single membrane envelope and feed spacer layer, or may comprise multiple membrane envelopes and feed spacer layers stacked and rolled together to form the element.

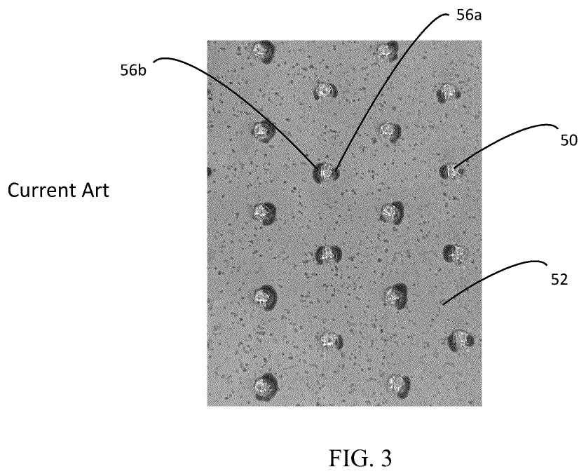

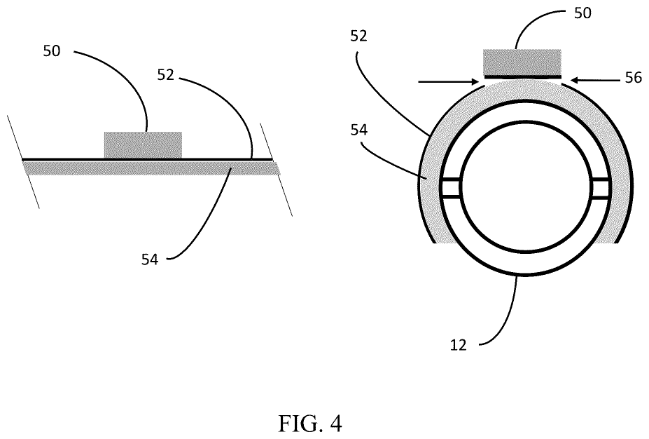

FIG. 3 depicts a membrane element opened for autopsy. The element of FIG. 3 is the prior art that shows a membrane sheet damaged by rigid circular spacers printed on the membrane sheet. As shown in FIG. 4, membrane sheet 54 with active membrane polymer layer 52, is rolled around center tube 12. Spacer features 50 can be rigid, and will not bend, when printed via ink jet printing, screen or stencil printing, or other printing methods. Consequently, polymer layer 52 is lifted off of the polysulfone support layer at break points 56a and 56b and allows ions to enter the damaged area and reduce the rejection characteristics of the assembled element. Hot melt material by its very nature is flexible with a Shore A durometer of approximately 70, and will conform to the membrane surface and not cause lifting at the edges of the printed pattern.

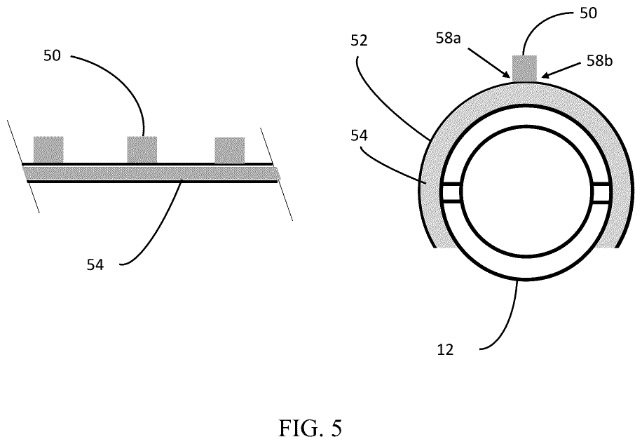

Likewise, it is more efficient from a plotting machine point of view to print straight lines rather than lines on the edges and dots in the middle of the sheet. FIG. 5 shows a cross section of narrow spacer 50. In one embodiment, the spacers can be 0.050 inch diameter dots. However, the same support area can be provided by a printed dashed line that is 0.020 inches wide and 0.100 inches long. Printed spacer 50 is also much more flexible and will conform to the curved surface when wrapped around center tube 12. This avoids cracks 58a and 58b in polymer coating 52 as membrane sheet 54 is wrapped around center tube 12.

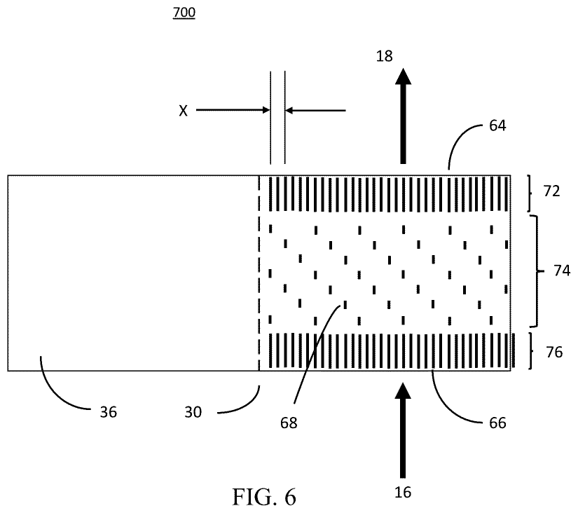

FIG. 6 represents an efficient print pattern for a hot melt printer. With a hot melt printer, a 0.050 inch diameter dot requires that the print head print a small circle and fill in the dot. This slows down the speed of the print head and extends the time necessary to print a full sheet of patterns on membrane sheet 36 beginning at inlet edge 66 and continuing to exit edge 64. However, the print head can travel in one direction and print the longer support line 76 on the inlet end 16 of the membrane sheet, print spacers 68 and continue to the other end of membrane sheet 36 to print exit lines 72 on the discharge end of the membrane. In an example embodiment, note that every other edge support line, 72 or 76, does not have spacers 68 printed in-line with entrance and exit edge support lines 72 and 76. When spacers 68 are printed in the same line as edge support lines 72 and 76, the print head can run at the same speed from the inlet to the exit end of membrane sheet 36, for instance, less dense space 74. When spacers 68 are not printed in-line with support lines 72 and 76, then the print travel head can be accelerated at high speed to the other end of membrane sheet 36 in less dense space 74 before slowing down to print support line 76, or support line 72, depending on the direction of travel of the print head. This process can reduce the time to print a full pattern on membrane sheet 36. The time necessary to print the full membrane spacer pattern on half of membrane sheet 36 will determine the ultimate efficiency and cost of printing a membrane sheet. The smaller the print time, the better. Spacing X of print lines 72, 74, 76, is preferably 0.10 inches, but can range in spacing from 0.20 to 1.0 inches. Also note that only half of membrane sheet 36 is printed and folded at fold line 30. This also speeds up the printing process by only printing one half of membrane sheet 36. Spacers 68 can be printed tall enough to create the necessary space between membrane sheets to create the fluid feed space.

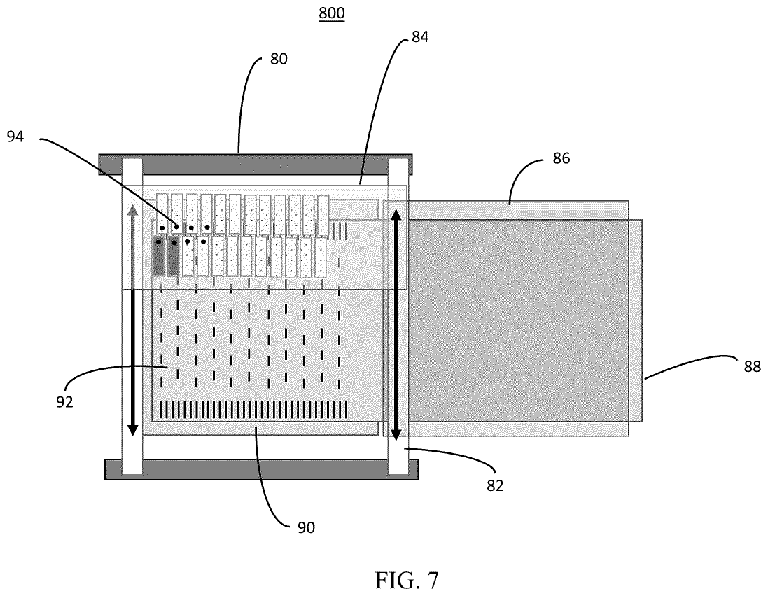

FIG. 7 represents a system 800 for printing pattern 92 on membrane sheet 88. Membrane sheet 88 can be individually cut and placed in printer system 800, or membrane sheet 88 can be roll fed on and off of printer system 800. Membrane sheet 88 is placed on printer system 800 so that the left end of membrane sheet 88 is positioned over vacuum table 90 to secure membrane sheet 88 in place, and to ensure membrane sheet 88 is flat and maintains a consistent vertical space between membrane sheet 88 and print heads 94. The right end of membrane sheet 88 can be placed on flat support table 86. Print heads 94 are mounted on print head support 84 which is mounted to X-axis stage or stages 82. Print head support 84 may also be mounted on Y-axis stages 80 depending on the design of the gantry system. Assuming print heads 94 are less than or equal to 2.0 inches wide, they can be offset and face each other to maximize the number of print heads 94 in the system. The more print heads 94 there are in the system, the faster a membrane sheet 88 can be printed.

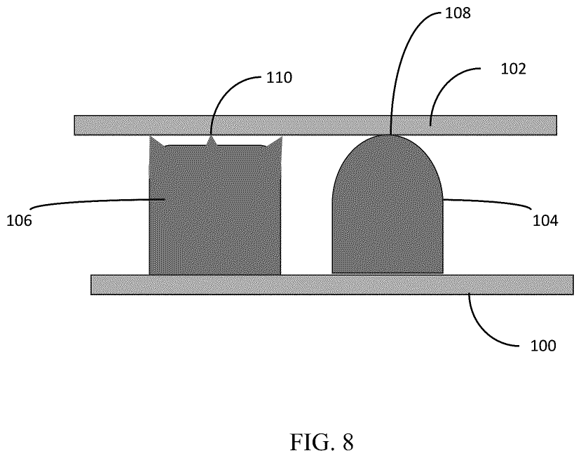

FIG. 8 shows hot melt spacer feature 104 and ink-jet or stencil spacer feature 106 between membrane sheets 100 and 102. Due to the melting and cooling characteristics of hot melt spacers, hot melt spacer 104 has a dome top that does not damage the active surface of membrane sheet 102. In contrast, spacer feature 106 applied with ink-jet or stencil processes can have sharp points 110 at the top of the spacer that can damage the sensitive polymer surface of membrane sheet 102. This characteristic of hot melt spacers makes it much less likely to damage the surface of membrane sheet 102. Hot melt spacer 104 can also be comprised of compounds that have very low tackiness. This feature of hot melt spacer 104 will help avoid damage to the sensitive polymer surface of membrane sheet 102 as the membrane element rolling process causes membrane sheets 100 and 102 to slide next to each other in the membrane element rolling process.

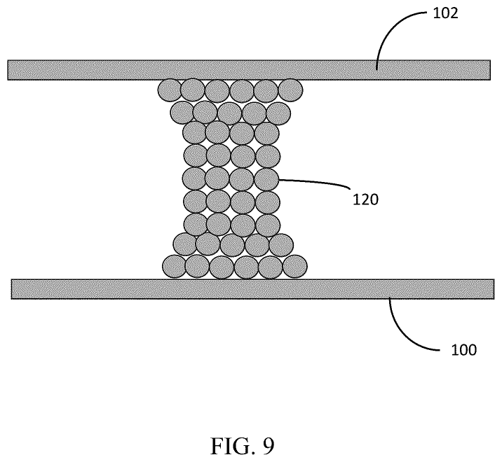

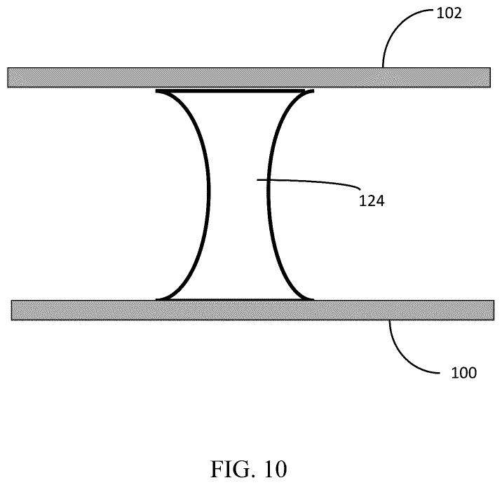

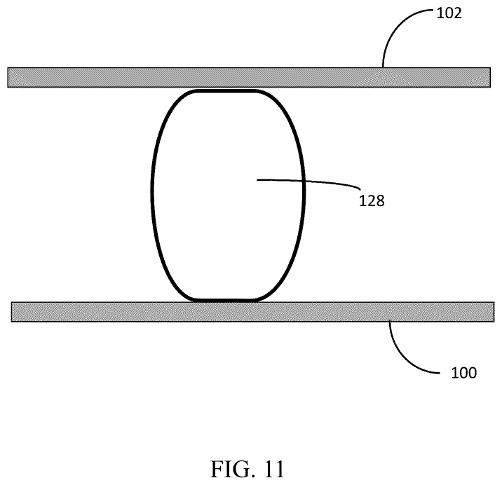

FIG. 9 shows the formation of a spacer feature that is built up with small hot melt drops 120 as they exit the hot melt print head. In actual practice, these individual drops will coalesce into a homogenous form. In this manner, various cross sections of the spacer can be constructed to help create turbulence in the feed fluid stream due to the shape of the spacer. In the embodiment of FIG. 9, a concave spacer can be constructed so that it is positioned between membrane sheets 100 and 102. FIG. 10 is a representation of a concave spacer feature where all of the hot melt drops have coalesced and cooled to make a solid spacer feature 124. FIG. 11 is an embodiment of a convex spacer feature 128 that solidifies and makes a homogeneous spacer feature 124.

The present invention has been described in connection with various example embodiments. It will be understood that the above description is merely illustrative of the applications of the principles of the present invention, the scope of which is to be determined by the claims viewed in light of the specification. Other variants and modifications of the invention will be apparent to those skilled in the art.

What is claimed is:

1. A membrane assembly for a spiral wound filtration element, comprising:
(a) a membrane sheet comprising a thin film composite structure comprising a porous structural layer, a support layer, and an active membrane layer;
(b) a plurality of edge spacers, comprising line segments of hot melt disposed on the active membrane layer, where each edge spacer has a length less than one fourth of the distance between first and second opposing edges of the membrane sheet, positioned near the first and second opposing edges and disposed with a long axis perpendicular to the first edge, wherein adjacent edge spacers are separated in a direction parallel to the first edge by a first distance;
(c) a plurality of intermediate spacers, comprising line segments of hot melt disposed on the active membrane layer, wherein each intermediate spacer has a length less than one fourth of the distance between first and second opposing edges of the membrane sheet, positioned in between the first and second opposing edges and disposed with a long axis perpendicular to the first edge, wherein adjacent intermediate spacers are separated in a direction parallel to the first edge by a second distance, where the second distance is greater than the first distance.

2. The membrane assembly of claim 1, wherein the second distance is an integer multiple of the first distance.

3. The membrane assembly of claim 1, wherein each edge spacer has a length of at least one inch and no more than four inches.

4. The membrane assembly of claim 1, wherein the plurality of intermediate spacers comprise a plurality of sets of intermediate spacers, wherein each set of intermediate spacers comprises a plurality of intermediate spacers each disposed along a single line perpendicular to the first edge, wherein the single line coincides with an edge spacer, and wherein the intermediate spacers in a set comprise line segments separated from each in a direction along the single line by a third distance, wherein the third distance is greater than the first distance.

5. The membrane assembly of claim 4, wherein each set of intermediate spacers is separated from an adjacent set of intermediate spacers by third distance, wherein the third distance is an integer multiple of the first distance.

6. The membrane assembly of claim 1, wherein each intermediate spacer has a cross-section that is rounded at an end away from the membrane sheet.

7. The membrane assembly of claim 1, wherein each intermediate spacer has a cross-section that has convex sides.

8. The membrane assembly of claim 1, wherein each intermediate spacer has a cross-section that has concave sides.

9. The membrane assembly of claim 1, wherein the hot melt is liquid at temperatures above 100 C.

10. The membrane assembly of claim 9, wherein the hot melt is liquid at temperatures above 170 C.

11. The membrane assembly of claim 1, wherein the hot melt has low tackiness.

12. The membrane assembly of claim 2, wherein the second distance is 3 times the first distance.

13. The membrane assembly of claim 1, wherein the intermediate spacers are 100 to 1500 microns wide, 250 to 5000 microns long, and 75 to 1200 microns tall.

14. A method of making the membrane assembly of claim 1, comprising:
(a) providing a membrane sheet, comprising a thin film composite structure comprising a porous structural layer, a support layer, and an active membrane layer;
(b) forming a plurality of edge spacers by depositing hot melt on the active membrane layer in a plurality of line segments, where each edge spacer has a length less than one fourth of the distance between first and second opposing edges of the membrane sheet, positioned near the first and second opposing edges and disposed with a long axis perpendicular to the first edge, wherein adjacent edge spacers are separated in a direction parallel to the first edge by a first distance;
(c) forming a plurality of intermediate spacers by depositing hot melt on the active membrane layer in a plurality of line segments, where each intermediate spacer has a length less than one fourth of the distance between first and second opposing edges of the membrane sheet, positioned in between the first and second opposing edges and disposed with a long axis perpendicular to the first edge, wherein adjacent intermediate spacers are separated in a direction parallel to the first edge by a second distance, where the second distance is greater than the first distance.

15. The method of claim 14, wherein forming a plurality of edge spacers comprises transporting a hot melt dispenser from near the first edge to near the second edge along a direction perpendicular to the first edge, and applying hot melt through the dispenser while the dispenser travels from near the first edge to a position at a distance from the first edge equal to the length of the edge spacer, and while the dispenser travels from a position at a distance from the second edge equal to the length of the edge spacer to near the second edge.

16. The method of claim 14, wherein forming a plurality of intermediate spacers comprises, while transporting the dispenser, applying hot melt through the dispenser while the dispenser travels from a position of the start of an intermediate spacer to a position of the end of an intermediate spacer.

17. The method of claim 16, wherein forming a plurality of intermediate spacers comprises applying hot melt through the dispenser on less than all of the dispenser excursions from the first edge to the second edge.

18. The method of claim 14, wherein the dispenser dispenses hot melt at a rate of less than 100 nanoliters per drop.

19. The method of claim 18, wherein the dispenser dispenses hot melt at a rate of less than 50 nanoliters per drop.

20. The method of claim 19, wherein the dispenser dispenses hot melt at a rate of less than 10 nanoliters per drop.

21. A method of producing a recycled spiral wound element, comprising:
(a) providing one or more initial spiral wound elements having spacing features comprising hot melt;
(b) disassembling the one or more initial spiral wound elements;
(c) recovering some or all of the hot melt from the initial spiral wound element;
(d) using the hot melt to produce one or more membrane assemblies as in claim 1;
(e) winding the one or more membrane assemblies into a recycled spiral wound element.
